(19) United States
(12) Patent Application Publication
(10) Pub. No.: US 2013/0132848 A1
(43) Pub. Date: May 23, 2013

(54) APPLICATION INTERACTION VIA MULTIPLE USER INTERFACES

(71) Applicant: Nikhil M. Bhatt, Cupertino, CA (US)

(72) Inventor: Nikhil M. Bhatt, Cupertino, CA (US)

(73) Assignee: Apple Inc., Cupertino, CA (US)

(21) Appl. No.: 13/300,408

(22) Filed: Nov. 18, 2011

(51) Int. Cl. G06F 3/01

(52) U.S. Cl. 715/733; 715/762

(57) ABSTRACT

Techniques for concurrently presenting multiple, distinct user interfaces for a single software application on multiple display devices. Each of the user interfaces can be interactive, such that user input received with respect to any of the user interfaces (presented on any of the display devices) can change the state of the application and/or modify data associated with the application. Further, this state or data change can be reflected in all (or a subset) of the user interfaces.

### BACKGROUND

The present disclosure relates in general to computer software, and in particular to techniques for enabling interaction with a software application via multiple, distinct user interfaces presented on multiple display devices.

In recent years, systems have been developed for mirroring the display output of a computing device such that the output is viewable on both a display of the computing device and a secondary display that may be remote from the computing device. For example, the “Airplay mirroring” feature implemented on certain Apple computing devices (e.g., the iPhone™ and iPad™) allows information that is presented by an application on a screen of the computing device to be wirelessly streamed to a television via an intermediate device (e.g., Apple TV™). Thus, when Airplay mirroring is enabled, users can simultaneously view the same media or application content on the computing device display and the television.

One current limitation with this feature is that the communication between the computing device and the intermediate device/television is generally one way (i.e., from the computing device to the intermediate device/television). Accordingly, there is no way for a user viewing the television to provide, though an input interface of the television or the intermediate device, commands back to the computing device for interacting with the application executing on the computing device.

### BRIEF SUMMARY

Embodiments of the present invention provide techniques for concurrently presenting multiple, distinct user interfaces for a single software application on multiple display devices. Each of the user interfaces can be interactive, such that user input received with respect to any of the user interfaces can change the state of the application and/or modify data associated with the application. Further, this state or data change can be reflected in all (or a subset) of the user interfaces.

By way of example, consider a software application executing on a computing device such as a desktop/laptop computer, a smartphone, a tablet, or the like. In one set of embodiments, the application can generate a first user interface (UI) configured to be presented on a first display device (e.g., a display that is connected to, or is an integral part of, the computing device). The first UI can have a first layout and expose a first set of functions that are tailored for a user viewing the first display device.

The application can further generate a second UI configured to be presented on a second display device (e.g., a television) while the first UI is being presented on the first display device. In certain embodiments, the second display device can be physically remote from the first display device and the computing device, and can be indirectly coupled with the computing device via an intermediate device (e.g., a digital media receiver, a router, an Internet-enabled cable/set-top box, etc.). The second UI can have a second layout and expose a second set of functions (distinct from the first UI) that are tailored for a user viewing the second display device.

Upon being presented with the first UI, the user viewing the first display device can interact with the application by entering, via an input device associated with the computing device, one or more commands for executing a function in the first set of functions exposed by the first UI. Similarly, upon being presented with the second UI, the user viewing the second display device can interact with the application by entering, via an input device associated with the intermediate device or the second display device, one or more commands for executing a function in the second set of functions exposed by the second UI. The commands entered with respect to the first and second UIs can then be received by the application and processed. The commands can include, e.g., commands for modifying a state of the application, modifying data and/or metadata associated with the application, and so on. In some embodiments, the application can generate updated versions of the first and/or second UIs in response to the received commands and transmit the updated UIs to the first and second display devices respectively for display.

With the foregoing techniques, users can concurrently interact with a single application via multiple UIs, where each UI is presented on a different display device and is controlled via a different input interface. As noted in the Background section, prior art mirroring mechanisms allow information that is presented by an application on a screen of a computing device to be wirelessly streamed to a remote television via an intermediate device. However, the communication between the application and the intermediate device/television is one way—a user viewing the television cannot provide, though an input interface of the television or the intermediate device, commands back to the computing device for interacting with the application. Rather, the application must be controlled via an input interface of the computing device. Certain embodiments of the present invention overcome this limitation and can allow users of both the computing device and the intermediate device/television to simultaneously control/interact with the application via respective input interfaces.

Further, the multiple UIs generated according to embodiments of the present invention can be distinct from each other and thus can be designed for different usage scenarios. For instance, the second UI described above can have a simplified layout and expose simplified control functions that are particularly suited for presenting and interacting with the application via, e.g., a television, since a user sitting in front of the television will likely be positioned relatively far from the screen and only have access to a simple input device (e.g., a remote control). In contrast, the first UI can have a more complex layout and expose more complex control functions that are particular suited for presenting and interacting with the application via, e.g., a computer display, since a user sitting in front of the computer display will likely be positioned relatively close to the screen and have access to one or more sophisticated input devices (e.g., keyboard, mouse, etc).

A further understanding of the nature and advantages of the embodiments disclosed herein can be realized by reference to the remaining portions of the specification and the attached drawings.

### BRIEF DESCRIPTION OF THE DRAWINGS

FIGS. 1-3 are simplified block diagrams of system environments in accordance with embodiments of the present invention.

FIG. 4 is a simplified block diagram of a computing/intermediate device, a display device, and an input device in accordance with an embodiment of the present invention.

FIG. 5 is a flow diagram of a process for enabling interaction with an application via multiple user interfaces in accordance with an embodiment of the present invention.

FIGS. 6-13 are example user interfaces in accordance with embodiments of the present invention.

FIG. 14 is a flow diagram of a process for translating commands received by an application in accordance with an embodiment of the present invention.

FIG. 15 is a flow diagram of a process performed by an intermediate device in accordance with an embodiment of the present invention.

### DETAILED DESCRIPTION

In the following description, for the purposes of explanation, numerous details are set forth in order to provide an understanding of various embodiments of the present invention. It will be apparent, however, to one skilled in the art that certain embodiments can be practiced without some of these details.

Embodiments of the present invention provide techniques for concurrently presenting multiple, distinct user interfaces for a single software application on multiple display devices. Each of the user interfaces can be interactive, such that user input received with respect to any of the user interfaces can change the state of the application and/or modify data associated with the application. Further, this state or data change can be reflected in all (or a subset) of the user interfaces.

By way of example, consider a software application executing on a computing device such as a desktop/laptop computer, a smartphone, a tablet, or the like. In one set of embodiments, the application can generate a first UI configured to be presented on a first display. The first UI can have a first layout and expose a first set of functions that are tailored for a user viewing the first display device.

The application can further generate a second UI configured to be presented on a second display device while the first UI is being presented on the first display device. In certain embodiments, the second display device can be physically remote from the first display device and the computing device, and can be indirectly coupled with the computing device via an intermediate device. The second UI can have a second layout and expose a second set of functions (distinct from the first UI) that are tailored for a user viewing the second display device.

Upon being presented with the first UI, the user viewing the first display device can interact with the application by entering, via an input device associated with the computing device, one or more commands for executing a function in the first set of functions exposed by the first UI. Similarly, upon being presented with the second UI, the user viewing the second display device can interact with the application by entering, via an input device associated with the intermediate device or the second display device, one or more commands for executing a function in the second set of functions exposed by the second UI. The commands entered with respect to the first and second UIs can then be received by the application and processed. The commands can include, e.g., commands for modifying a state of the application, modifying data and/or metadata associated with the application, and so on. In some embodiments, the application can generate updated versions of the first and/or second UIs in response to the received commands and transmit the updated UIs to the first and second display devices respectively for display.

In a particular embodiment, the software application can be a digital photo application, such as iPhoto™ or Aperture™ (both developed by Apple Inc.). In this embodiment, the digital photo application can generate one UI for presentation on a computing device display and another UI for presentation on a television (e.g., via an intermediate device such as Apple TV™). The computing device UI can have a first layout and expose a first set of photo management/manipulation functions that are designed for viewing/execution via the computing device display and an associated computer input device (e.g., keyboard, mouse, touchscreen, etc.). The television UI can have a second layout and expose a second set of photo management/manipulation functions that are designed for viewing/execution via the television and an associated remote control device. Thus, with this embodiment, users can have the flexibility to interact with the digital photo application from two distinct contexts: (1) the computing device context (via the computing device display and computer input device) and (2) the television context (via the television and remote control device). This is in contrast to prior art mirroring implementations, where application content could be mirrored to multiple display devices, but the application could only be controlled from the context of a single display device. Further, since the computing device and television UIs can be distinct from each other, users of the computing device display and the television can interact with the digital photo application in a manner that is suited for their respective environments.

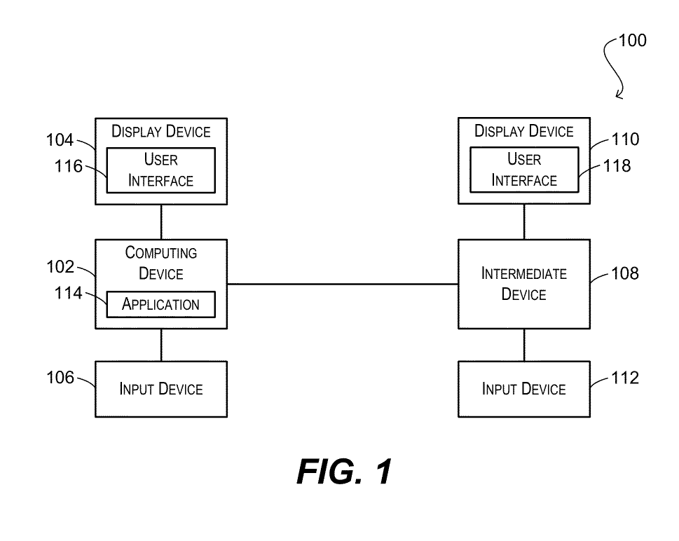

FIG. 1 is a simplified block diagram of a system environment 100 according to an embodiment of the present invention. As shown, system environment 100 can include a computing device 102 that is communicatively coupled with a display device 104 and an input device 106. Computing device 102 can be any type of device capable of storing and executing one or more software applications. For example, computing device 102 can be a desktop or laptop computer, a smartphone, a tablet, a video game console, or the like. In certain embodiments, computing device 102 can store and execute a software application 114 that is configured to generate multiple application UIs for presentation on multiple display devices. Application 114 is described in further detail below.

Display device 104 can be any type of device capable of receiving information (e.g., display signals) from computing device 102 and outputting the received information on a screen or other output interface to a user. In one set of embodiments, display device 104 can be external to computing device 102. For instance, display device 104 can be a computer monitor, a television, or some other type of standalone display that is in wired or wireless communication with computing device 102. Alternatively, display device 104 can be an integral part of computing device 102, such as an embedded LCD or OLED panel. In certain embodiments, display device 104 can include an audio output device for presenting audio (in addition to images/video) to a user.

Input device 106 can be any type of device that includes an input interface for receiving commands from a user and providing the commands to computing device 102, such as a wired or wireless keyboard, mouse, remote control, game controller, microphone, or the like. Like display device 104, input device 106 can be external to, or an integral part of, computing device 102. As an example of the latter case, input device 106 can be a touch-based interface that is integrated into a display screen or other surface of computing device 102.

In addition to devices 102, 104, and 106, system environment 100 can further include an intermediate device 108 that is communicatively coupled with a display device 110 and an input device 112. As shown, intermediate device 108 can be in communication with computing device 102 via a wired or wireless communications link. Like computing device 102, intermediate device 108 can be any type of device capable of storing and executing one or more software applications. In a particular embodiment, intermediate device 108 can execute a software application (not shown) that is configured to receive, from computing device 102, information pertaining to an application UI (e.g., UI 118) generated by application 114 and cause the UI to be presented on display device 110. In addition, the software application can be configured to receive, via input device 112, user commands for interacting with the UI and transmit the user commands to computing device 102 for processing. In certain embodiments, the application executing on intermediate device 108 can be a component of software application 114 executing computing device 102. Alternatively, the two applications can be distinct. In the latter case, the application executing on intermediate device 108 can be, e.g., a generic application that is configured to interoperate with a multitude of different applications to enable the presentation of application content on display device 110 and the reception of user commands pertaining to the application content via input device 112.

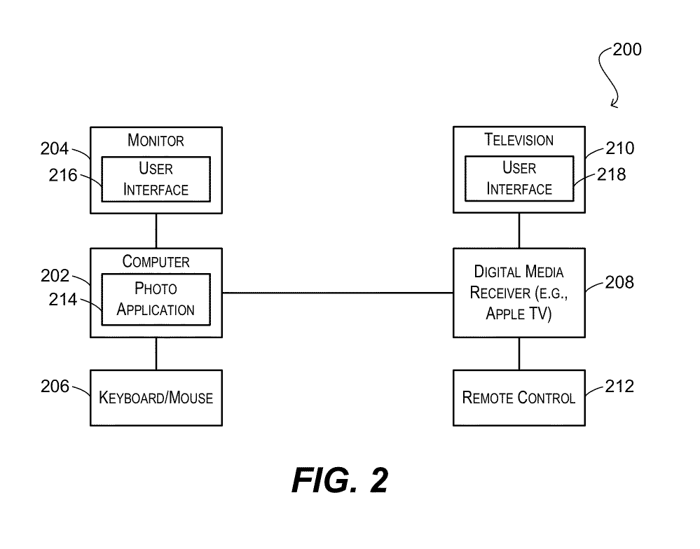

In some embodiments, intermediate device 108 can be identical to computing device 102. For example, if computing device 102 is a tablet device, intermediate device 108 can also be a tablet device. In other embodiments, the two devices can differ in a manner that reflects different usage scenarios. For instance, in a particular embodiment, computing device 102 (in combination with display device 104 and input device 106) can be used primarily for traditional computing tasks and thus may correspond to a desktop/laptop computer, a tablet, or the like, whereas intermediate device 108 (in combination with display device 110 and input device 112) can be used primarily for media consumption/management and thus may correspond to a digital media receiver (e.g., Apple TV), a media router, an Internet-enabled cable/set-top box, a video game console, or the like. An example of such an embodiment is described with respect to FIG. 2 below.

Display device 110 can be any type of device capable of receiving information (e.g., display signals) from intermediate device 108 and outputting the received information on a screen or other output interface to a user. In one set of embodiments, display device 110 can be external to intermediate device 108. For instance, display device 110 can be a computer monitor, a television, or some other type of standalone display that is in wired or wireless communication with intermediate device 108. Alternatively, display device 110 can be an integral part of intermediate device 108, such as an embedded LCD or OLED panel. In a particular embodiment, display device 110 and intermediate device 108 can, in combination, correspond to an Internet-enabled television set. In certain embodiments, display device 110 can include an audio output device for presenting audio (in addition to images/video) to a user.

Input device 112 can be any type of device that includes an input interface for receiving commands from a user and providing the commands to intermediate device 108, such as a wired or wireless keyboard, mouse, remote control, game controller, microphone, or the like. Like display device 110, input device 112 can be external to, or an integral part of, intermediate device 108. As an example of the latter case, input device 112 can be a touch-based interface that is integrated into a display screen or other surface of intermediate device 108.

In one set of embodiments, devices 108, 110, and 112 can be physically remote from devices 102, 104, and 106. For example, devices 108, 110, and 112 can be physically located in one room of a house (e.g., family room), while devices 102, 104, and 106 are physically located in a different room of the house (e.g., study or den). Alternatively, these two groups of devices can be located in substantially the same location.

As noted above, computing device 102 can, in certain embodiments, store and execute a software application 114 that is configured to generate a number of distinct UIs for presentation on multiple display devices. Application 114 can be, e.g., a productivity application (e.g., word processing, spreadsheet, presentation creation, etc.), a media management/editing/playback application, a video game, a web browser, or any other type of software application that can be operated via a user interface. In various embodiments, each of the UIs generated by application 114 can be interactive, such that user input received with respect to any of the UIs can be used to control/interact with application 114.

For example, as shown in FIG. 1, application 114 can generate a first UI 116 for presentation on display device 104. UI 116 can have a first layout and expose a first set of functions that are designed to viewed/executed via display device 104 and input device 106. Application 114 can further generate a second UI 118 for presentation on display device 110 while UI 116 is being presented on display device 104. For instance, UI 118 can be generated by application 114 and transmitted from computing device 102 to intermediate device 108. Intermediate device 108 can, in turn, cause UI 118 to be displayed on display device 110. UI 118 can have a second layout and expose a second set of functions that are distinct from UI 116 and are designed to be viewed/executed via display device 110 and input device 112.

Upon viewing UI 116 on display device 104, a user of devices 102/104/106 can interact with application 114 by entering, via input device 106, one or more commands for executing a function in the first set of functions exposed by UI 116. Similarly, upon viewing UI 118 on display device 110, a user of devices 108/110/112 can interact with application 114 by entering, via an input device 112, one or more commands for executing a function in the second set of functions exposed by UI 118. The commands entered with respect to UIs 116 and 118 can then be received by application 114 and processed. In certain embodiments, application 114 can generate updated versions of UIs 116 and/or 118 in response to the received commands and transmit the updated UIs to display devices 104 and/or 110 respectively for display.

FIG. 2 illustrates a system environment 200 that represents a specific example of system environment 100 depicted in FIG. 1. As shown in FIG. 2, system environment 200 can include a desktop/laptop computer 202 (corresponding to computing device 102) that is communicatively coupled with a computer monitor 204 (corresponding to display device 104) and a keyboard/mouse 206 (corresponding to input device 106). Computer 202 can be configured to store and execute a digital photo application 214 (corresponding to application 114). In addition, system environment 200 can include a digital media receiver 208 (corresponding to intermediate device 108) that is communicatively coupled with a television 210 (corresponding to display device 110) and a remote control 212 (corresponding to input device 112). Computer 202 and digital media receiver 208 can be in communication via either a wired or wireless link.

Although digital media receiver 208 and television 210 are shown as separate devices, in certain embodiments they can the combined into a single device (e.g., an Internet-enabled television). Further, remote control 212 can be a simple remote (e.g., a remote control with a fixed input interface, such a fixed number of buttons) or a complex remote (e.g., a remote control with a configurable and/or dynamically modifiable input interface). As an example of the latter case, remote control 212 can be implemented using a smartphone or tablet.

In one set of embodiments, digital photo application 214 can generate a first UI 216 for display on monitor 204 that is optimized for viewing/interaction via monitor 204 and keyboard/mouse 206. By way of example, UI 216 can include a “gallery” view of imported photos (thereby taking advantage of the high resolution/close viewing distance of computer monitors) and various complex functions for editing and/or managing the photos (thereby taking advantage of the relatively sophisticated input interfaces provided by a keyboard and mouse). Examples of such complex functions include retouching portions of a photo, organizing photos into various directories/albums, and so on. Other types of UI layouts and functions are also possible.

Digital photo application 214 can further generate a second UI 218 for presentation on television 210 while UI 216 is being presented on monitor 204. For instance, UI 218 can be wirelessly streamed from computer 202 to digital media receiver 208. Digital media receiver 208 can then cause UI 218 to be presented on television 210. In various embodiments, UI 218 can be distinct from UI 216 and can be optimized for viewing/interaction via television 210 and remote control 212. By way of example, UI 218 can present each photo in the gallery in a slideshow format (thereby accommodating the lower resolution/longer viewing distance of televisions) and can expose simplified functions for interacting with the photos (thereby accommodating the relatively simple input interface provided by a remote control). Examples of such simplified functions include initiating or pausing the slideshow, navigating among photos in the slideshow (e.g., advancing to the next photo or returning to previous photo), setting a rating or other metadata for a photo (e.g., like/dislike, flag/hide, etc.), changing the amount of metadata displayed with the photo (e.g., filename, date taken, GPS data with inset map, etc.), and so on. In certain embodiments, digital photo application 214 can support the presentation of videos in addition to photos. In these embodiments, the functions supported by UI 218 can further include, e.g., playing, pausing, and/or seeking through a particular video. Other types of UI layouts and functions are also possible.

In various embodiments, a command received by digital photo application 214 with respect to UI 216 (via keyboard/mouse 206) or UI 218 (via remote control 212) can change the state of the application and/or modify data/metadata associated with one or more photos. These changes can subsequently be reflected in either or both UIs. For example, if a viewer of television 210 enters a command for assigning a “like” rating for a photo via remote control 212, digital photo application 214 can save this rating, generate updated versions of UIs 216 and/or 218 that reflect the rating, and cause the updated UIs to be displayed on monitor 204 and television 210 respectively. As another example, if a viewer of monitor 204 enters a command for applying a particular filter to a photo via keyboard/mouse 206, application 214 can apply the filter to the photo, generated updated versions of UIs 216 and/or 218 that reflect the filtered photo, and cause the updated UIs to be displayed on monitor 204 and television 210 respectively.

In some embodiments, the updated versions of the UIs generated by digital photo application 214 can include aural (in addition to visual) changes. For instance, the updated version of UI 218 that is generated in response to a user “like” rating can include a specification of a sound file to be played when the UI is displayed on television 210. This sound file can be sent with the UI from computer 202 to digital media receiver 208, or can be preloaded on digital media receiver 208 and played back on demand (for performance and/or latency reasons).

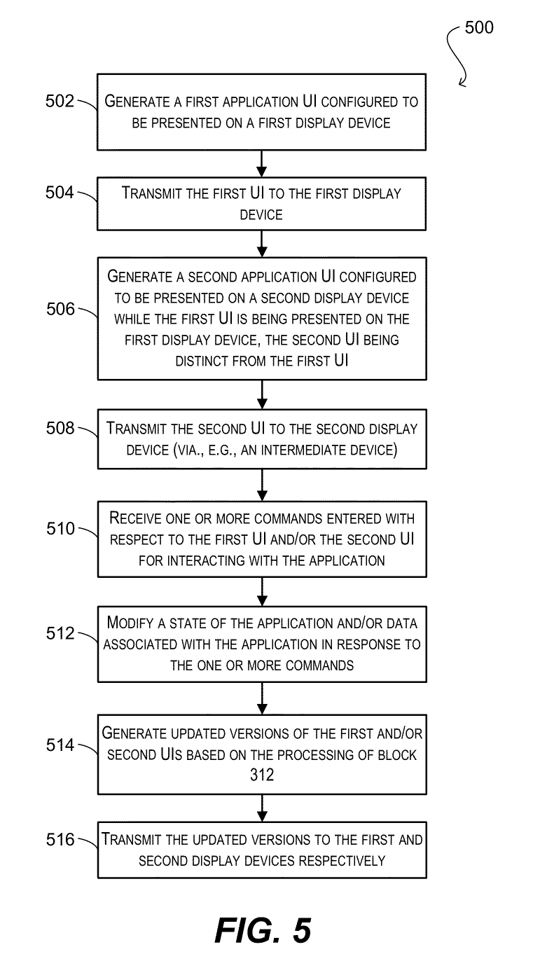

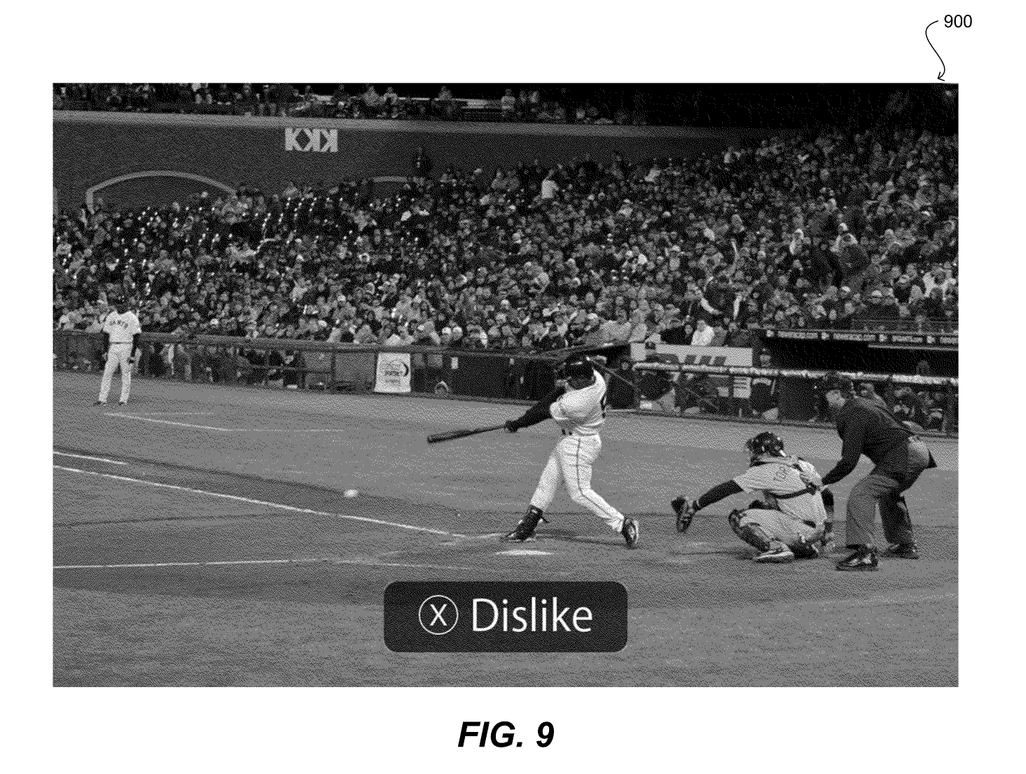

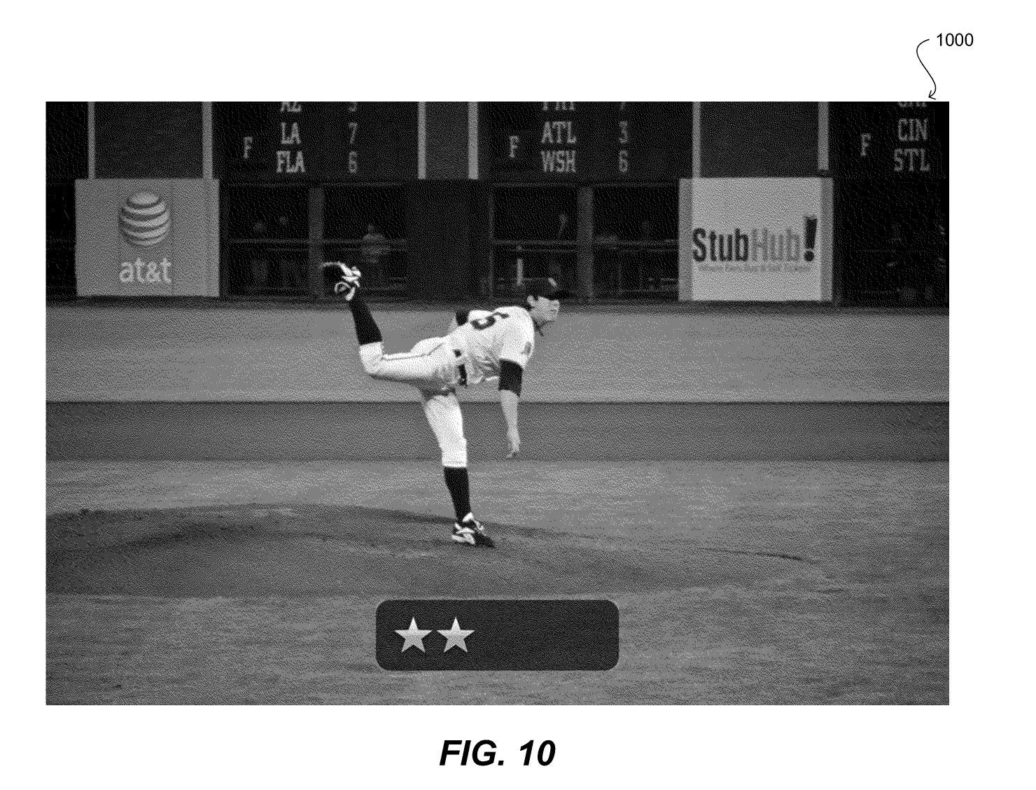

With the techniques described above, users can concurrently interact with digital photo application 214 from the context of two different environments—a typical computing environment (as exemplified by computer 202, monitor 204, and keyboard/mouse 206) and a typical home entertainment environment (as exemplified by digital media receiver 208, television 210, and remote control 212). In certain embodiments, this addresses a limitation with prior art mirroring techniques, where an application can be mirrored to both a computing device display and an intermediate device/television, but cannot be controlled from the context of the intermediate device/television. Further, the UIs presented in each environment (i.e., 216 and 218) can be distinct from each other and thus can be tailored for their respective environments. Additional examples of UIs that can be generated by digital photo application 214 are described with respect to FIGS. 5-12 below.

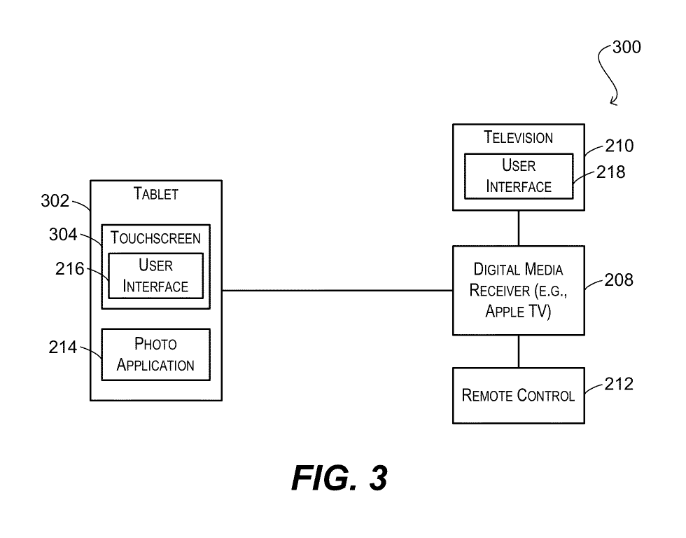

FIG. 3 illustrates a system environment 300 that represents yet another example of system environment 100 depicted in FIG. 1. As shown, system environment 300 includes components/features that are substantially similar to system environment 200 of FIG. 2, but includes a tablet device 302 that takes the place of computer 202. Further, tablet device 302 incorporates a touchscreen 304 that is configured to perform the functions of monitor 204 and keyboard/mouse 206.

It should be appreciated that FIGS. 1-3 are illustrative and not intended to limit embodiments of the present invention. For example, although application 114/214 is shown as generating two UIs in each FIGS. 116/216 and 118/218), any number of such user interfaces can be generated. One of ordinary skill in the art will recognize other variations, modifications, and alternatives.

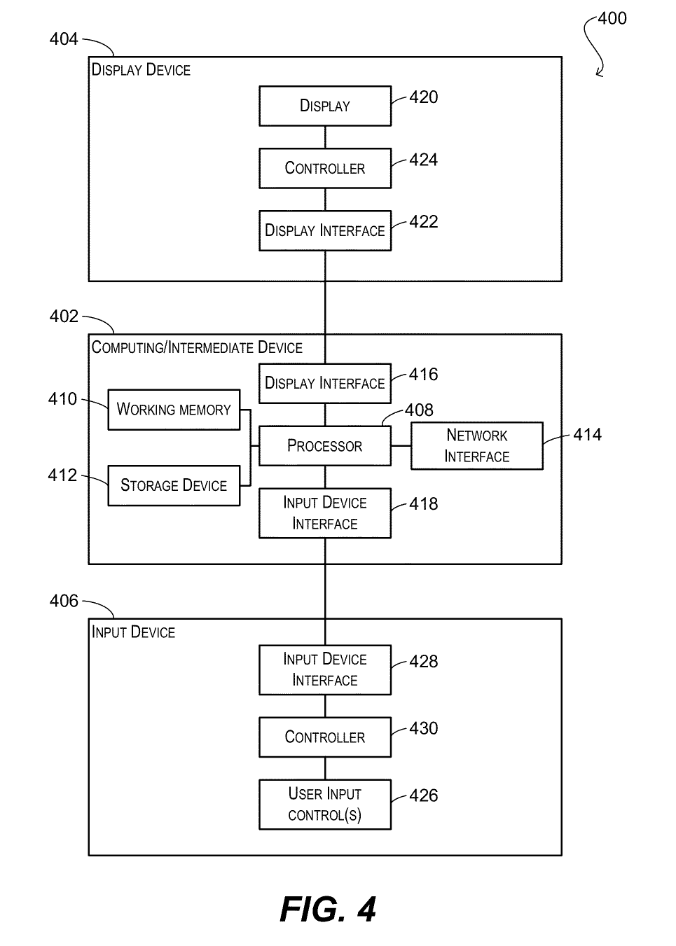

FIG. 4 is a simplified block diagram of a system 400 comprising a computing/intermediate device 402, a display device 404, and an input device 406 according to an embodiment of the present invention. In one set of embodiments, devices 402, 404, and 406 can be used to implement devices 102, 104, and 106 of FIG. 1 respectively. Alternatively or additionally, devices402, 404, and 406 can be used to implement devices 108, 110, and 112 of FIG. 1 respectively.

As shown, computing/intermediate device 402 can include a processor 408, a working memory 410, a storage device 412, a network interface 414, a display interface 416, and an input device interface 418.

Processor 408 can be implemented as one or more integrated circuits, such as a microprocessor or microcontroller. In various embodiments, processor 408 can be responsible for carrying out one or more functions attributable to computing/intermediate device 402, such as executing application 114 of FIG. 1. Processor 408 can also manage communication with other devices, such as display device 404 (via display interface 416) and input device 406 (via input device interface 418).

Working memory 410 can include one or more volatile memory devices (e.g., RAM) for temporarily storing program code such as operating system code, application code, and the like that is executable by processor 408.

Storage device 412 can provide persistent (i.e., non-volatile) storage for program and data files. Storage device 412 can be implemented, for example, using magnetic disk, flash memory, and/or any other non-volatile storage medium. In some embodiments, storage device 412 can include non-removable storage components such as a non-removable hard disk drive or flash memory drive. In other embodiments, storage device 412 can include removable storage media such as flash memory cards. In a particular embodiment, storage device 412 can be configured to store program and data files used by application 114 of FIG. 1.

Network interface 414 can serve as an interface for communicating data between computing/intermediate device 402 and other devices or networks. In embodiments where computing/intermediate device 402 is used to implement computing device 102 of FIG. 1, network interface 414 can be used to enable network communication with intermediate device 108. Conversely, in embodiments where computing/intermediate device 402 is used to implement intermediate device 108 of FIG. 1, network interface 414 can be used to enable network communication with computing device 102. In various embodiments, network interface 414 can be a wired (e.g., twisted pair Ethernet, USB, etc.) or wireless (e.g., WiFi, cellular, etc.) interface.

Display interface 416 can include a number of signal paths configured to carry various signals between computing/intermediate device 402 and display device 404. In one set of embodiments, display device 404 can be a standalone device that is external to computing/intermediate device 402. In these embodiments, display interface 416 can include a wired (e.g., HDMI, DVI, DisplayPort, etc.) or wireless (e.g., Wi-Di, etc.) interface for connecting computing/intermediate device 402 with display device 404. In alternative embodiments, display device 404 can be an integral part of computing/intermediate device 402. In these embodiments, display interface 416 can include a data bus for internally driving display device 404.

Input device interface 418 can include a number of signal paths configured to carry various signals between computing/device 402 and input device 406. Input device interface 418 can include any one of a number of common peripheral connectors/interfaces, such as USB, Firewire, Bluetooth, IR (Infrared), RF (Radio Frequency), and the like. In certain embodiments, input device interface 418 and display interface 416 can share a common interface that is designed for both display and input device connectivity, such as Thunderbolt.

Display device 404 can include a display 420, a display interface 422, and a control 424. Display 420 can be implemented using any type of panel or screen that is capable of generating visual output to a user, such as LCD, Plasma, OLED, or the like.

Display interface 422 can be substantially similar in form/function to display interface 416 of computing/intermediate device 402 and can be used to communicatively couple display device 404 with interface 416. By way of example, if display interface 416 of computing/intermediate device 402 includes an HDMI output port, display interface 422 of display device 404 can include a corresponding HDMI input port.

Controller 424 can be implemented as one or more integrated circuits, such as a microprocessor or microcontroller. In one set of embodiments, controller 424 can execute program code that causes the controller to process information received from computing/intermediate device 402 via display interface 422 and generate, based on the processing, an appropriate video signal for display on display 420. In embodiments where display device 404 is integrated into computing/intermediate device 402, the functionality of controller 424 may be subsumed by processor 408 of device 402.

Input device 406 can include one or more user input controls 426, an input device interface 428, and a controller 430. User input controls 426 can include any of a number of controls that allow a user to provide input commands, such as a scroll wheel, button, keyboard, trackball, touchpad, microphone, touchscreen, and so on. In various embodiments, the user can activate one or more of controls 426 on input device 406 and thereby cause input device 406 to transmit a signal to computing/intermediate device 402.

Input device interface 428 can be substantially similar in form/function to input device interface 418 of computing/intermediate device 402 and can be used to communicatively couple input device 406 with interface 418. By way of example, if input device interface 418 of computing/intermediate device 402 includes an IR signal receiver, input device interface 428 of input device 406 can include a corresponding IR signal transmitter.

Controller 430 can be implemented as one or more integrated circuits, such as a microprocessor or microcontroller. In one set of embodiments, controller 430 can execute program code that causes the controller to process user inputs received via user input controls 426 and determine an appropriate signal to be transmitted to computing/intermediate device 402.

It should be appreciated that system 400 is illustrative and not intended to limit embodiments of the present invention. For example, devices 402, 404, and 406 can each have other capabilities or include other components that are not specifically described. One of ordinary skill in the art will recognize other variations, modifications, and alternatives.

FIG. 5 is a flow diagram of a process 500 for enabling interaction with an application via multiple user interfaces according to an embodiment of the present invention. In one set of embodiments, process 500 can be performed by application 114 executing on computing device 102 of FIG. 1. As software, process 500 can be encoded as program code stored on a non-transitory computer readable storage medium.

At block 502, application 114 can generate a first application UI (e.g., 116) configured to be presented on a first display device (e.g., 104). As discussed with respect to FIG. 1, UI 116 can have a first layout and expose a first set of functions that are tailored for a user of display device 104 (and associated input device 106). For example, if display device 104 is a computer monitor and input device 106 is a keyboard/mouse, the UI 116 can have a layout and expose functions that are particularly suited for viewing/execution via a monitor and a keyboard/mouse. At block 504, application 114 can transmit UI 116 to display device 104 for display.

Upon generating/transmitting the first UI, application 114 can establish a connection with an intermediate device (e.g., 108) that is communicatively coupled with a second display device (e.g., 110). Application 114 can then generate a second application UI (e.g., 118) configured to be presented on display device 110 while UI 116 is being presented on display device 104 (block 506). In various embodiments, UI 118 can have a second layout and expose a second set of functions (distinct from UI 116) that are tailored for a user of display device 110 (and associated input device 112). For example, if display device 110 is a television and input device 112 is a remote control, UI 118 can have a layout and expose functions that are particularly suited for viewing/execution via a television and a remote control. At block 508, application 114 can transmit UI 118 to display device 110 via intermediate device 108 for display (block 408).

At block 510, application 114 can receive one or more commands entered with respect to UI 116 and/or the UI 118 for interacting with the application. For instance, application 114 can receive a first set of commands received with respect to UI 116 that are entered by a user via input device 106. Application 114 can also receive a second set of commands received with respect to UI 118 that are entered by a user via input device 112. The received commands can then be processed by application 114.

In one set of embodiments, the commands received at block 410 can include commands for modifying a state of application 114 and/or data/metadata associated with the application. In these embodiments, the command processing can include updating the application state and/or application data/metadata based on the received commands (block 512).

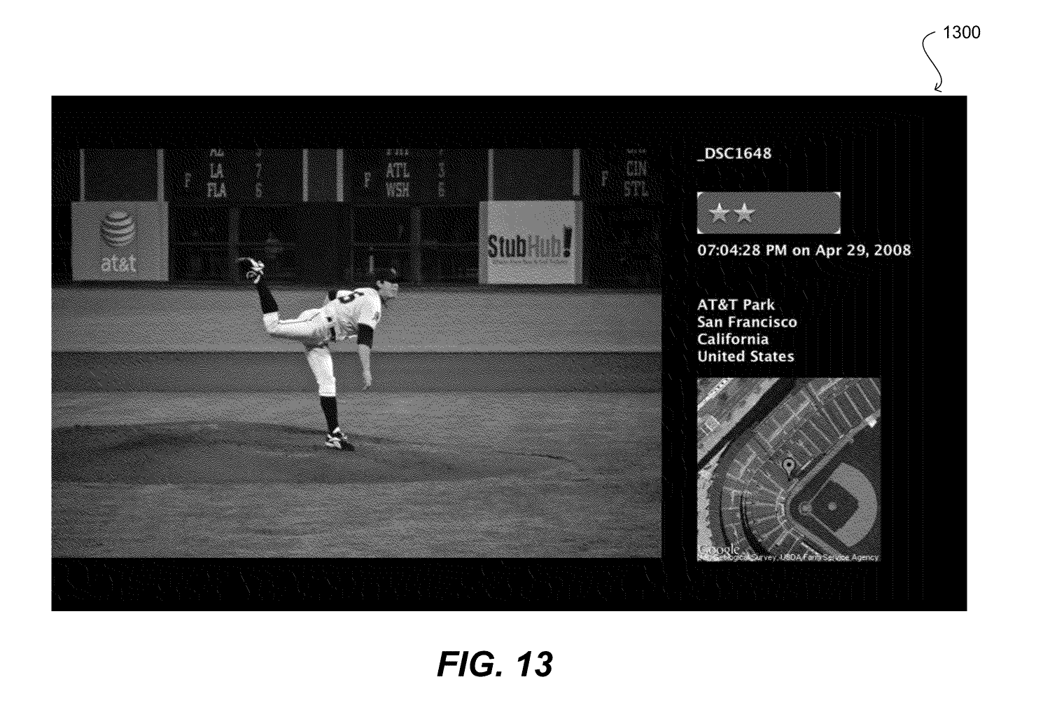

In a particular embodiment, a command received with respect to either UI 116 or 118 can be mapped to a different command based on a predefined rule set. The mapped command can then be processed by application 114. By way of example, assume a user of UI 118 enters a command (via input device 112) for assigning a “like” rating to a media item presented in UI 118. Upon receiving this command, application 114 can consult a rule set pertaining to media item rankings and determine that the “like” rating should be translated into a “3 star” rating (or some other type of rating value). Application 114 can then apply and save the “3 star” rating (rather than the “like” rating) with the media item. This enables a user to enter, via a relatively unsophisticated input device such as a remote control, a simplified command that is subsequently converted into a more complex command/function by application 114. Additional details regarding this translation/mapping process is provided with respect to FIG. 13 below.

Once the commands received at block 510 have been processed, application 114 can generate updated versions of UI 116 and/or 118 (block 514) and transmit the updated UIs to display devices 104 and 110 respectively for display (block 516). Process 500 can then return to block 510, such that additional commands entered with respect to UIs 116 and 118 can be received and processed. This flow can continue until, e.g., application 114 is disconnected from intermediate device 108/display device 110 (thereby causing application 114 to stop generating/updating user interface 110) or application 114 is closed.

It should be appreciated that process 500 is illustrative and that variations and modifications are possible. For example, although process 500 indicates that application 114 (executing on computing device 102) is configured to perform the tasks of generating UIs 116 and 118, processing user input commands, and generating updated versions of the UIs in response to the commands, in alternative embodiments some portion of these tasks can be performed by intermediate device 108. As another example, steps described as sequential may be executed in parallel, order of steps may be varied, and steps may be modified, combined, added, or omitted. One of ordinary skill in the art will recognize other variations, modifications, and alternatives.

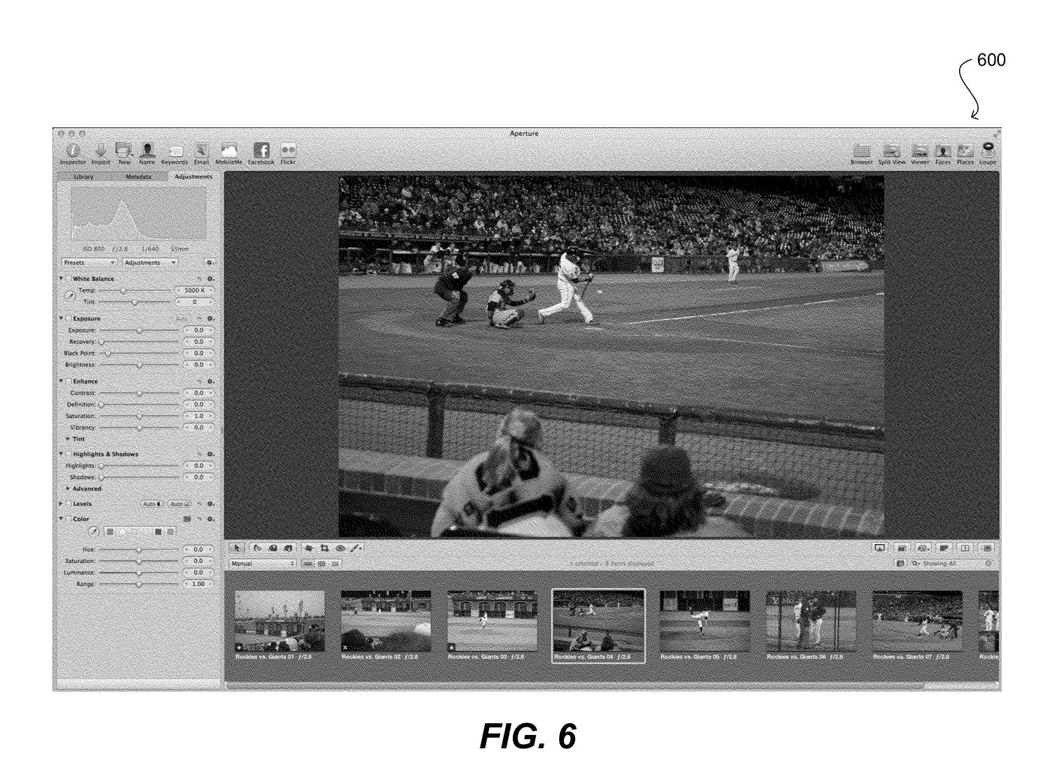

As discussed with respect to FIG. 2, in certain embodiments application 114 of FIG. 1 can be a digital photo application (214) that is configured to generate a first UI 216 for presentation on a computer monitor/display 204 and a second UI 218 for presentation on a television 210 (via digital media receiver 208). FIGS. 6-13 illustrate example user interfaces that can correspond to UIs 216 and 218 according to various embodiments of the present invention. For instance, FIG. 6 illustrates a UI 600 that can be generated by digital photo application 214 for presentation on monitor 204. As shown, UI 600 can include a gallery view of photos and a number of user interface elements (e.g., buttons, poplists, slider bars, text fields, menus, etc.) for carrying out various manipulation/management functions with respect to the displayed photos. Generally speaking, the user interface elements in UI 600 can be designed for activation via a pointing device that is commonly used in conjunction with a computer and computer monitor, such as a mouse or trackpad device.

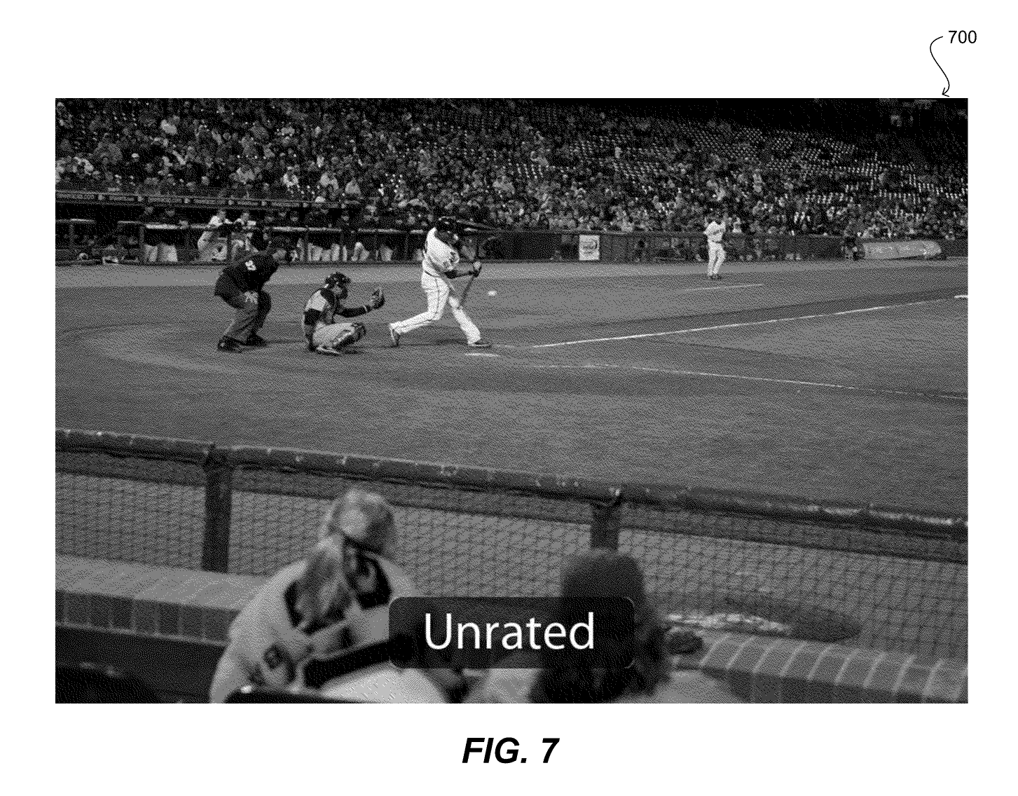

FIG. 7 illustrates a UI 700 that can be generated by photo application 214 for presentation on television 210 while UI 600 of FIG. 6 is being presented on monitor 204. As shown, UI 700 can include an enlarged view of a single photo in the gallery of UI 600. Further, UI 700 can include an indication of a rating associated with the photo (in this case, the photo is “unrated”).

In contrast to UI 600, UI 700 can expose various functions that can be easily performed by a viewer of television 210 using remote control 212. For instance, in one set of embodiments, the television viewer can assign a particular rating to the photo, such as “like,” dislike,” or a star rating. These ratings can be mapped to particular buttons on remote control 212, such that the assignment process can be carried out by activating a single button. By way of example, a “like” rating can be mapped to a “menu up” remote control button, a “dislike” rating can be mapped to a “menu down” remote control button, and a star rating of 1-5 can be mapped to numeric “1-5” remote control buttons.

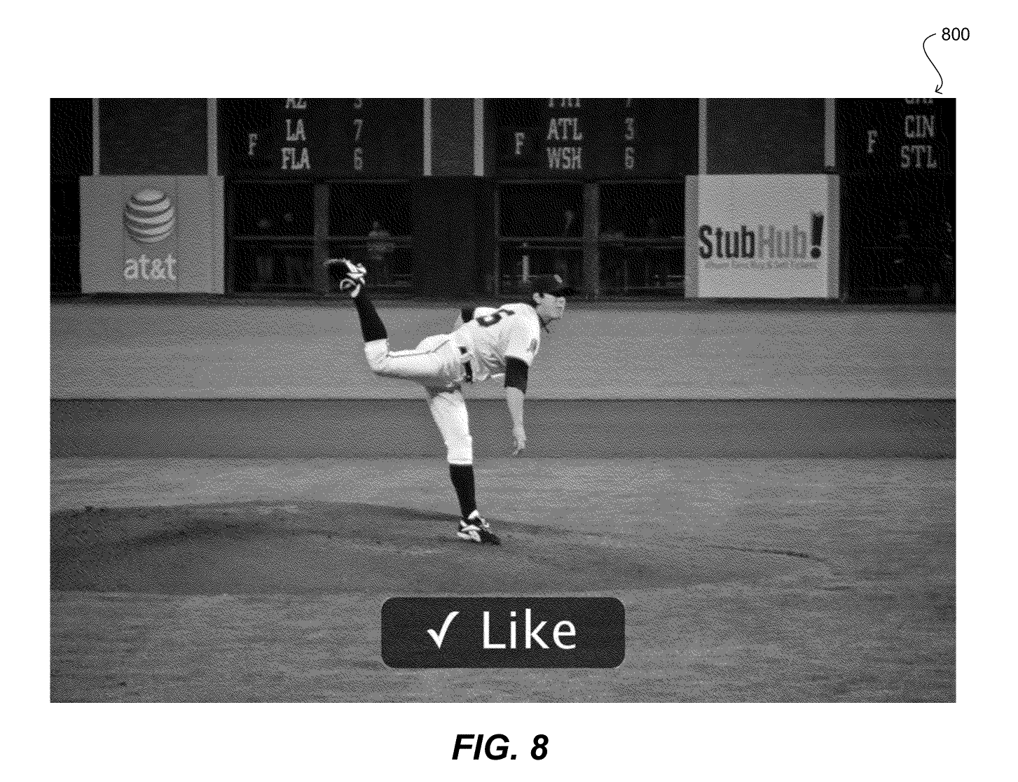

Upon receiving a command for a particular rating, digital photo application 214 can save the rating with the photo and update the UI presented on television 210 to display the new rating. For example, FIGS. 8-10 illustrate versions of UI 700 (800-1000) that depict the photo as being assigned a rating of “like,” “dislike,” and “2 stars” respectively. In certain embodiments, digital photo application 214 can also update the UI presented on monitor 204 to reflect the rating entered with respect to television 210. For instance, UI 600 of FIG. 6 may be updated such that the “like” rating viewable in UI 800 on television 210 is also viewable on monitor 204.

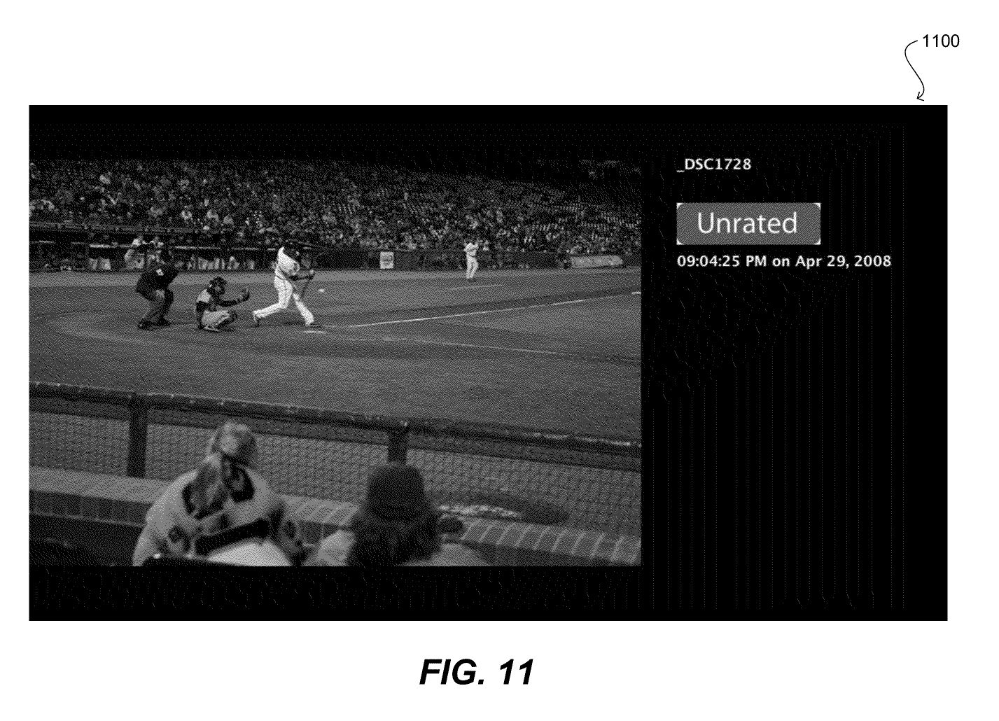

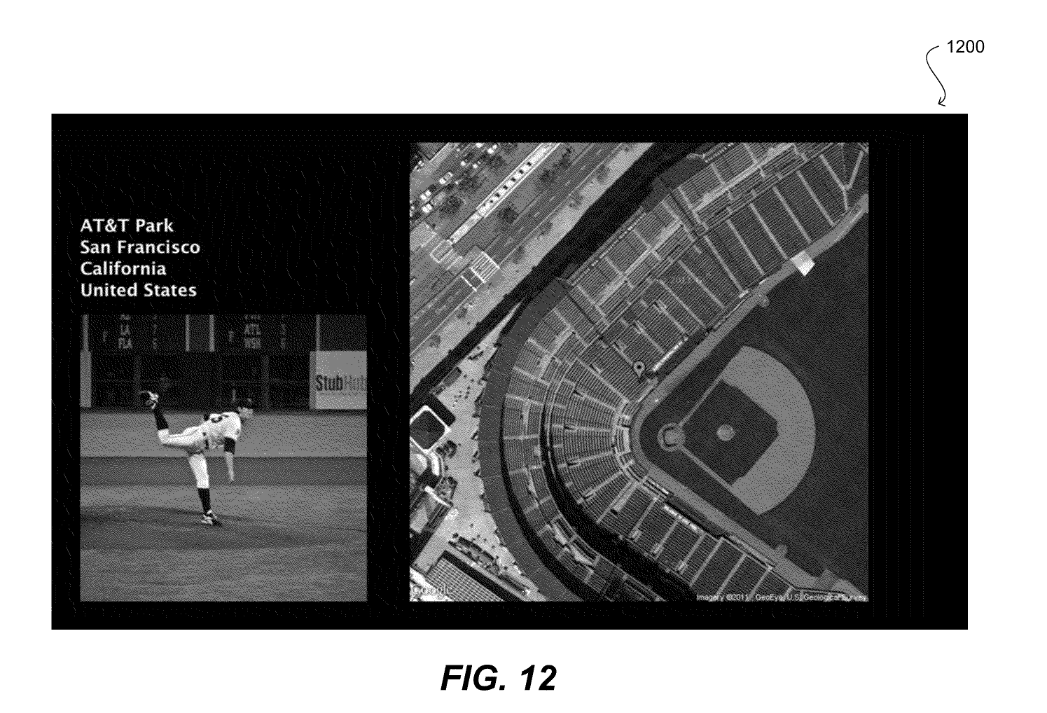

In addition to functions for assigning ratings, the UI generated by digital photo application 214 for presentation on television 210 can also expose various functions for, e.g., playing/pausing a photo slideshow, navigating between photos of the slideshow, playing/pausing a video file, performing minor edits on a photo, changing the amount of metadata displayed with a photo, and so on. All of these additional functions can be mapped to buttons on remote control 212. For example, FIG. 11 illustrates a UI 1100 that shows the photo from UI 700 in an inset window, along with the filename, rating, and capture date of the photo. This configuration can be generated by digital photo application 214 in response to, e.g., activation of a particular remote control button that is assigned to change the amount of metadata displayed with the photo. FIGS. 12 and 13 illustrate additional UIs 1200 and 1300 that depict additional configurations with further metadata (e.g., GPS location information with inset map). Each of these additional UIs can be generated by digital photo application 214 in response to activation of an appropriate remote control button.

In embodiments where remote control 212 is a simple remote (e.g., a remote control with a fixed input interface, such a fixed number of buttons) one example set of mappings between remote control buttons and functions can be the following:
up/down—assign like rating/dislike rating
select (e.g., center button)—change UI layout and/or amount of metadata displayed
left/right—navigate to previous image/next image
play/pause—Play/pause the slideshow and/or video file

Other types of button mappings are also possible. In certain embodiments, the mappings shown above can change in different contexts. For example, when a map is visible in the UI (per FIGS. 12 and 13), the up/down buttons may be used to zoom in/out of the map rather than assign like/dislike ratings.

It should be appreciated that the UIs depicted in FIGS. 6-13 are provided as examples only and are not intended to limit embodiments of the present invention. Numerous other types of UIs can be generated by digital photo application 114 for presentation and interaction via monitor 204 and television 210. One of ordinary skill in the art will recognize many variations, modifications, and alternatives.

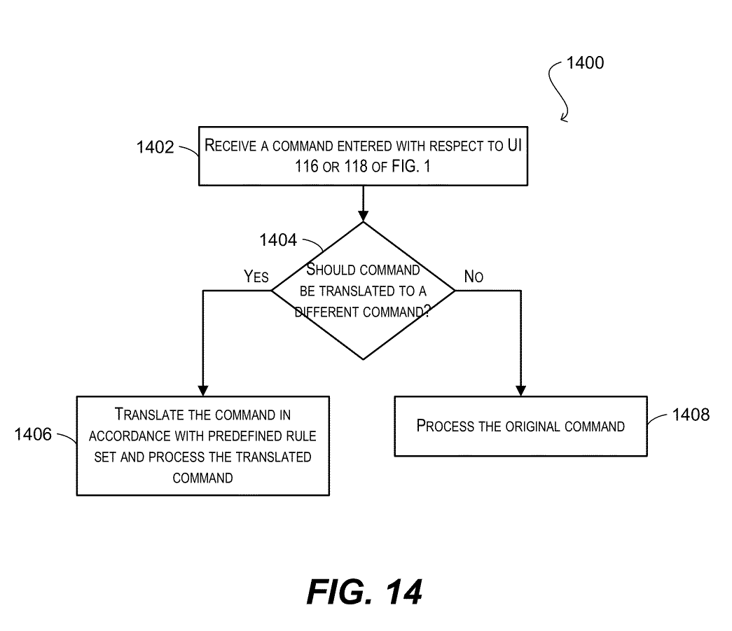

FIG. 14 is a flow diagram of a process 1400 for translating/mapping commands received by application 114 of FIG. 1 from one type of command to a different type of command according to an embodiment of the present invention. One problem with using a relatively unsophisticated input device such as a remote control is that complex commands cannot be easily entered via its input interface. The translation/mapping process of FIG. 14 addresses this issue and enables a user to enter, via a remote control, a simplified command that is subsequently converted into a more complex command/function by the application. Process 1400 can be implemented in software, hardware, or a combination thereof. As software, process 1400 can be encoded as program code stored on a non-transitory computer readable storage medium.

At block 1402, application 114 can receive a command entered with respect to UI 116 or UI 118 of FIG. 1. For example, this command can correspond to one of the commands received at block 510 of FIG. 5. In a particular embodiment, the received command can be a command for assigning a particular metadata rating (e.g., “like”) to a media item presented in UI 116 or 118.

At block 1404, application 114 can consult a predefined rule set to determine whether the command should be translated or mapped to a different type of command. This rule set can be defined by a user of application 114, or can be seeded by an application developer of application 114.

If the received command should be translated per block 1404, application 114 can translate the command in accordance with the rule set and process the translated version of the command (block 1406). For instance, returning to the example above, application 114 can consult a rule set pertaining to media item rankings and determine that the command for assigning a “like” rating should be translated into a command for assigning a “3 star” rating. Application 114 can then apply and save the “3 star” rating (rather than the “like” rating) with the media item.

If the received command should not be translated per block 1404, application 114 can simply process the original command (block 1408).

It should be appreciated that process 1400 is illustrative and that variations and modifications are possible. For example, steps described as sequential may be executed in parallel, order of steps may be varied, and steps may be modified, combined, added, or omitted. One of ordinary skill in the art will recognize other variations, modifications, and alternatives.

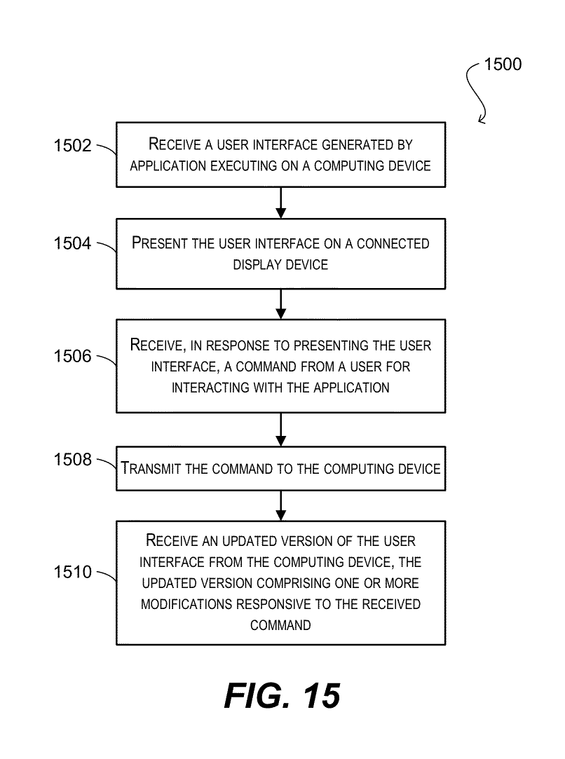

FIG. 15 is a simplified block diagram of a process 1500 can that be performed by an intermediate device according to an embodiment of the present invention. In one set of embodiments, process 1500 can be performed by intermediate device 108 of FIG. 1 while process 400 of FIG. 4 is being performed by application 114. Process 1500 can be implemented in software, hardware, or a combination thereof. As software, process 1500 can be encoded as program code stored on a non-transitory computer readable storage medium.

At block 1502, intermediate device 108 can receive a user interface (e.g., 118) generated and transmitted by application 114 executing on computing device 102. In various embodiments, this user interface can correspond to the “second UI” transmitted by application 114 at block 508 of process 500. UI 118 can include one or more functions for interacting with application 114.

At block 1504, intermediate device 108 can cause UI 118 to be presented on a connected display device (e.g., 110). In certain embodiments, the processing of block 1504 can include one or more steps for rendering UI 118. For example, in a particular embodiment, intermediate device 108 can receive an incomplete UI specification from application 114 at block 1502, and thus may need to composite/combine the received information with data stored locally to generate the final version of UI 118. In other embodiments, intermediate device 108 can received a complete UI specification from application 114 at block 1502, and thus can simply forward this information to display device 110 for display.

Once UI 118 has been presented to a user via display device 110, intermediate device 108 can receive, via an associated input device (e.g., 112), a command from a user for interacting with application 114 (block 1506). For example, the command can be configured to change a state of application 114, and/or modify data/metadata associated with the application. Intermediate device 108 can then transmit the command to computing device 102 for processing by application 102 (block 1508). In certain embodiments, intermediate device 108 can perform some pre-processing on the command prior to transmission to computing device 102. Alternatively, intermediate device 108 can forward the raw command, without any pre-processing, to computing device 102.

At block 1510, intermediate device 108 can receive an updated version of UI 118 from application 114/computing device 102, where the updated version includes one or more modifications responsive to the command received at block 1506. For instance, if the command was directed to assigning a rating to a media item presented in UI 118, the updated version of UI 18 can include an indication of the newly assigned rating. Intermediate device 108 can then cause the updated version of UI 118 to be presented on display device 110. After block 1510, process 1500 can return to block 1506, such that additional commands entered with respect to UI 118 can be received and forwarded to application 114/computing device 102. This flow can continue until, e.g., application 114 is disconnected from intermediate device 108 or application 114 is closed.

It should be appreciated that process 1500 is illustrative and that variations and modifications are possible. For example, steps described as sequential may be executed in parallel, order of steps may be varied, and steps may be modified, combined, added, or omitted.

While the invention has been described with respect to specific embodiments, one skilled in the art will recognize that numerous modifications are possible. In some embodiments, circuits, processors, and/or other components of a computer system or an electronic device may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on. Further, while the embodiments described above may make reference to specific hardware and software components, those skilled in the art will appreciate that different combinations of hardware and/or software components may also be used and that particular operations described as being implemented in hardware can also be implemented in software or vice versa.

Computer programs incorporating some or all of the features described herein may be encoded on various computer readable storage media; suitable media include magnetic disk (including hard disk) or tape, optical storage media such as CD, DVD, or Blu-ray, and the like. Computer readable storage media encoded with the program code may be packaged with a compatible device or provided separately from other devices. In addition, program code may be encoded and transmitted via wired, optical, and/or wireless networks conforming to a variety of protocols, including the Internet, thereby allowing distribution, e.g., via Internet download.

Thus, although the invention has been described with respect to specific embodiments, it will be appreciated that the invention is intended to cover all modifications and equivalents within the scope of the following claims.

What is claimed is:

1. A method comprising:
generating, by an application executing on a first computing device, a first user interface configured to be presented on a first display device;
generating, by the application, a second user interface configured to be presented on a second display device while the first user interface is being presented on the first display device, the second user interface being distinct from the first user interface; and
receiving, by the application, a first set of commands entered with respect to the first user interface and a second set of commands entered with respect to the second user interface, the first and second sets of commands comprising commands for interacting with the application.

2. The method of claim 1 wherein the first and second sets of commands include a command for modifying a state of the application.

3. The method of claim 1 wherein the first and second sets of commands include a command for modifying data associated with the application.

4. The method of claim 1 wherein the first display device is directly coupled with the first computing device.

5. The method of claim 4 wherein the first display device is an integral part of the first computing device.

6. The method of claim 1 wherein the second display device is indirectly coupled with the first computing device via a second computing device.

7. The method of claim 6 wherein the first set of commands is entered via an input device of the first computing device, and wherein the second set of commands is entered via an input device of the second computing device.

8. The method of claim 1 further comprising:
modifying, in response to the first and second sets of commands, a state of the application or data associated with the application;
generating updated versions of the first and second user interfaces based on the modified state or data.

9. A system comprising:
a memory configured to store program code for an application; and
a processor configured to execute the application, the executing comprising:
generating a first user interface and a second user interface for the application, the first user interface exposing a first set of functions for controlling the application, the second user interface exposing a second set of functions for controlling the application that is different from the first set of functions;
transmitting the first user interface to a first display device for presentation on a first display device; and
transmitting the second user interface to an intermediate device for presentation on a second display device communicatively coupled with the intermediate device.

10. The system of claim 9 wherein the first and second user interfaces are transmitted for concurrent presentation on the first and second display devices respectively.

11. The system of claim 9 wherein the system is a computer system and wherein the intermediate device is a digital media receiver.

12. The system of claim 11 wherein the first display device is a computer monitor and wherein the second display device is a television.

13. The system of claim 9 wherein the second set of functions is a subset of the first set of functions.

14. The system of claim 9 wherein the application is an image editing or image management application.

15. The system of claim 14 wherein the first user interface includes a set of images, and wherein the second user interface includes a first image from the set of images.

16. The system of claim 15 wherein the second set of functions includes a function for modifying metadata associated with the first image.

17. The system of claim 15 wherein the second set of functions include a function for reconfiguring the second application interface to change an amount of metadata displayed with the first image.

18. A method comprising:
receiving, by a digital media device from a computer, a user interface for an application executing on the computer, the digital media device being physically remote from the computer;
presenting, by the digital media device, the user interface on a television;
receiving, by the digital media device in response to presenting the user interface, a command from a user for interacting with the application;
transmitting, by the digital media device, the command to the computer; and
receiving, by the digital media device, an updated version of the user interface from the computer, the updated version of the user interface comprising one or more modifications responsive to the received command.

19. The method of claim 18 wherein the user interface includes an image, and wherein the command is configured to modify metadata associated with the image.

20. The method of claim 18 wherein the command is received from a remote control device in communication with the digital media device.

21. A digital media device comprising:
a first communications interface configured to enable communication with a computer;
a second communications interface configured to enable communication with a television;
a third communications interface configured to enable communication with a remote control device; and
a processor configured to:
receive, over the first communication interface, a user interface for an application executing on the computer, the user interface including a representation of a photo;
transmit, over the second communication interface, the user interface for presentation on the television;
receive, over the third communication interface, a remote control command requesting modification of metadata associated with the photo; and
transmit, over the first communication interface, the remote control command to the computer,
wherein the application executing on the computer is configured to modify the metadata associated with the photo in accordance with the remote control command.

22. A non-transitory computer readable storage medium having stored thereon a program code for a photo editing or management application, the program code comprising:
code for generating a first user interface for the photo editing or management application, the first user interface including a first layout designed for presentation on a computer monitor;
code for generating a second user interface for the photo editing or management application, the second user interface including a second layout designed for presentation on a television, the second layout being different from the first layout;
code for simultaneously presenting the first user interface on the computer monitor and the second user interface on the television; and
code for receiving, via the second user interface presented on the television, one or more commands for interacting with the photo editing or management application.

23. The non-transitory computer readable medium of claim 22 wherein the first user interface is configured to display a gallery of photos and wherein the second user interface is configured to display a single photo in the gallery at a time in a slideshow format.

24. The non-transitory computer readable medium of claim 23 wherein the one or more commands includes: a command for navigating between photos in the gallery, a command for assigning a rating to a photo, or a command for changing an amount of metadata presented with a photo.

25. The non-transitory computer readable medium of claim 24 wherein, upon receiving the command for assigning a rating to a photo, the program code further comprises:
code for translating the rating from a first format to a second format based on a predefined rule; and
code for storing the rating in the second format with the photo.
